(19) United States
(12) Patent Application Publication
(10) Pub. No.: US 2005/0002101 A1
(43) Pub. Date: Jan. 6, 2005

(54) Dynamically controllable light modulator using phase diffraction grating and display using the same

(75) Inventors: Nakjoong Kim, Seoul (KR); Won-Jae Joo, Gyeonggi-do (KR)

Correspondence Address: Finnegan, Henderson, Farabow,;Garrett & Dunner, L.L.P., 1300 I Street, N.W., Washington, DC, 20005-3315, US

(73) Assignee: HANYANG HAK WON CO., LTD.

(21) Appl. No.: 10/671,557

(22) Filed: Sep. 29, 2003

(30) Foreign Application Priority Data
Jul. 2, 2003 (KR) 10-2003-0044504

(51) Int. Cl. G02B 5/18

(52) U.S. Cl. 359/573

(57) ABSTRACT

The present invention relates to a dynamically controllable light modulator, which is capable of controlling light intensity by controlling electric fields applied to the light modulator, and a display using the same. It is an object of the present invention to solve the problems of the conventional light modulator by providing a dynamically controllable light modulator controlled by a uniform electric field and a display using the same. The dynamically controllable light modulator for achieving the object of the present invention comprises a phase diffraction grating member wherein a diffraction grating portion of which the thickness changes periodically is formed on one surface of the phase diffraction grating member; a phase modulation member whose one surface is attached to the diffraction grating portion of the phase diffraction grating member; and electrodes provided on the other surfaces of the phase diffraction grating member and the phase modulation member.

### FIELD OF THE INVENTION

The present invention relates to a dynamically controllable light modulator, which is capable of controlling light intensity by controlling electric fields applied to the light modulator, and a display using the same.

### BACKGROUND OF THE INVENTION

Some conventional light modulators use acousto-optic material, electro-optic material such as liquid crystal, and the like. The light modulator using acousto-optic material is fabricated by connecting a transducer to a piezoelectric element. If an electric signal is inputted into the light modulator, the transducer generates an acoustic wave and transfers it to the piezoelectric element. The transferred acoustic wave forms a diffraction grating in the piezoelectric element. If a laser beam enters the diffraction grating vertically, it is diffracted. However, this type of light modulator cannot control the formation of diffraction grating in a local area. Also, since the frequency of the acoustic wave is low, the angle of diffracted light is small. The Bragg angle is generally below one degree due to the acoustic wave of hundreds of MHz, though it varies depending on the wavelength of the light source.

Diffraction occurs when monochromatic light passes through a medium in which a refractive index or an absorption is periodically modulated. For example, diffraction can occur even if light passes through a glass plate on which lines are periodically drawn with ink. In this case, a laser beam is used as monochromatic light having monochromatic wavelength. Diffraction is classified into a Raman-Nath diffraction and a Bragg diffraction. The Raman-Nath diffraction, that is, a multiple diffraction that has plural diffracted lights such as a first-order diffracted light, a second-order diffracted light, and the like, occurs when the medium, in which a refractive index is modulated, is relatively thin. The Bragg diffraction, in which only the first-order diffracted light is generated, occurs when the medium is relatively thick. It is usually used to distinguish between these diffraction regimes by defining a parameter Q, which is mainly dependent on the thickness of the medium and the grating spacing, as described below.

$$Q = \frac{2 πλ L}{n {Λ}^{2}} \qquad ( 1 )$$

wherein λ is the wavelength of an incident laser beam; L is the thickness of the grating; Λ is the grating spacing; and n is the average refractive index of the grating. If the parameter Q is over one, Bragg diffraction occurs; otherwise, Raman-Nath diffraction occurs.

The most widely used light modulators employ Mach-Zehnder interferometer and electro-optic material. They divide light into two equal parts guided by a waveguide, and then are combined again, wherein the phase of one of the divided lights is modulated using the electro-optic material. Since combining the lights leads to constructive or destructive interference according to the phase modulation, the light modulator modulates the intensity of the final output light. However, it is not easy to fabricate the apparatus using a light modulator since it requires the use of a waveguide. There are also some limitations in reducing the thickness of the apparatus, wherein light progresses in the direction of said thickness.

Another type of light modulator uses electro-optic material such as liquid crystal that is positioned between polarizers, which are perpendicular to each other. Since such a light modulator induces birefringence as an electric field is applied to the light modulator, the polarization state of the transmitted light changes. Accordingly, the intensity of the light transmitting the last polarizer changes depending on the electric field that is applied to the electro-optic material. However, since such an apparatus requires the use of polarizers, light transmittance decreases.

An active controllable light modulator or an information recording and/or reproducing apparatus is another example of a light modulator using electro-optic material, which uses a voltage dependent phase variable member and comb-type transparent electrodes, as disclosed in Korean Patent Application No. 10-2001-0017156.

FIGS. 1a and 1b show a structure of active controllable light modulator X using conventional comb-type transparent electrodes. A first comb-type transparent electrode 3 and a second comb-type transparent electrode 5 are attached to the insides of two opposite glass panels 4. A phase modulation member 1 such as liquid crystal is inserted between the first and second transparent electrodes 3, 5. The transparent electrodes 3, 5 comprise combs 3a, 5a, which are arranged parallel at regular widths d1 and regular intervals d2. The first and second transparent electrodes 3, 5 are positioned at both sides of the phase modulation member 1 so that the combs 3a, 5a do not overlap each other. Namely, each of the combs 3a of the first transparent electrode 3 is positioned between each adjacent comb 5a of the second transparent electrode 5. The interval d2 is an important parameter in defining the diffraction angle of the first-order beam of light in the active controllable light modulator X. An alternating current (AC) voltage source 6 supplies AC voltages having a certain frequency to the comb-type transparent electrodes 3, 5. AC electric fields are generated in respective portions of the phase modulation member 1 facing the combs 3a and 5a, according to the levels of the AC voltages supplied to the comb-type transparent electrodes 3, 5. If the levels of the AC voltage supplied to the comb-type transparent electrodes 3, 5 are set to different values, electric fields generated in the combs 3a and electric fields generated in the combs 5a will differ in intensity. As such, the phase of light beams transparent through the portions of the phase modulation member 1 facing the combs 3a differs from the phase of light beams transmitted through the portions of the phase modulation member 1 facing the combs 5a. Thus, if a laser beam from a light source 10 is diffracted when it passes through the light modulator X, it is modulated to diffracted lights A, B. Further, in the active controllable light modulator X, diffraction does not occur by blocking the supply of the AC voltage from the AC voltage source 6 to the phase modulation member 1 or equalizing the levels of the AC voltages supplied to the comb-type transparent electrodes 3, 5. Therefore, the laser beam from the light source 10 is transmitted to the light modulator X as indicated by M. Accordingly, as described above, the generation of the diffracted lights A, B is controlled by the AC power supply 6.

However, it is not easy to control the phase of the comb-type transparent electrodes, which has several micrometer periods. The width d1 or interval d2 of the comb-type transparent electrodes influences the distribution of electric fields formed in an element or a performance of the element. Further, since it is not easy to fabricate the comb-type electrodes in the form of a two-dimensional array, it is impossible to apply the light modulator to a two-dimensional display.

### SUMMARY OF THE INVENTION

It is an object of the present invention to solve the problems of the conventional light modulator by providing a dynamically controllable light modulator controlled by a uniform electric field and a display using the same.

The dynamically controllable light modulator for achieving the object of the present invention comprises a phase diffraction grating member wherein a diffraction grating portion of which the thickness changes periodically is formed on one surface of the phase diffraction grating member; a phase modulation member whose one surface is attached to the diffraction grating portion of the phase diffraction grating member; and electrodes provided on the other surfaces of the phase diffraction grating member and the phase modulation member. At least one of the electrodes may comprise a transparent electrode, conductor with which a glass substrate is coated, ITO electrode, or metal. The phase modulation member may be provided only in concave portions of the diffraction grating portion. The diffraction grating portion may be expressed in the form of thickness functions such as a harmonic, triangle, square, or saw tooth wave. Refractive index of the phase modulation member may change as the voltage supplied thereto changes. The phase modulation member may comprise organic material containing nonlinear chromophore, liquid crystal, or electro-optic crystals. The phase diffraction grating member may have predetermined thickness and intervals so that Bragg diffraction occurs. A laser beam may be irradiated to the dynamically controllable light modulator. A polarization direction of the laser beam may be determined so that the difference between the refractive index of the phase diffraction grating member and refractive index of the phase modulation member is maximized. The display for achieving the object of the present invention comprises a phase diffraction grating member wherein the diffraction grating portion of which thickness changes periodically is formed on one surface of the phase diffraction grating member; a phase modulation member whose one surface is attached to the diffraction grating portion of the phase diffraction grating member; plural transparent electrodes which are provided on the other surface of the phase modulation member, and which are patterned in a two-dimensional array; common electrode which is provided on the other surface of the phase diffraction grating member; one or more light sources; and a power supply driver; wherein each of the plural transparent electrodes is connected to a drive element, said drive elements and said common electrode are connected to the power supply driver. The common electrode may comprise metal or transparent material. The length of each of the plural transparent electrodes may be over three times as long as the grating spacing. The one or more light sources may comprise three separate sources for monochromatic laser beams of red, green and blue. Incident angles of the three laser beams may be controlled so that diffracted lights fall in the same direction. Otherwise, incident angles of the three laser beams may be controlled so that diffraction efficiency of each laser beam is maximized; in this case, the display should further comprise a rotatable mirror for reflecting the diffracted lights so to be directed in the same direction. The monochromatic laser beams of red, green and blue may be irradiated alternately and repeatedly. Also, the monochromatic laser beams of red, green and blue may be irradiated simultaneously.

### BRIEF DESCRIPTION OF THE DRAWINGS

FIGS. 1a and 1b are plane and side views of a dynamically controllable conventional light modulator using comb-type transparent electrodes.

FIG. 2 is a side view of a dynamically controllable light modulator using a phase diffraction grating according to the present invention.

FIG. 3 is a perspective view of the diffraction grating portion of the phase diffraction grating member of the dynamically controllable light modulator according to the present invention.

FIG. 4 is an explanatory view of the Bragg diffraction which occurs in a dynamically controllable, transmissive-type light modulator (hereinafter, the transmissive type modulator) according to the present invention.

FIG. 5 is an explanatory view of the Bragg diffraction which occurs in a dynamically controllable, reflective-type light modulator (hereinafter, the reflective type modulator) according to the present invention.

FIG. 6 is an explanatory view of the laser beam path in the reflective type modulator of the present invention.

FIG. 7 is an explanatory view of the laser beam path in a modified example of the reflective type modulator shown in FIG. 6.

FIG. 8 is a view of the modified example shown in FIG. 7.

FIG. 9 is a perspective view of a display using the transmissive type modulator according to the present invention.

FIG. 10 is a perspective view of a display using the reflective type modulator according to the present invention.

FIG. 11 is a perspective view of the display using the transmissive type modulator with a rotatable mirror controlling the various directions of the output laser beams R, G and B.

FIG. 12 is a view illustrating the relationship between the transmitted lights and the diffracted lights in the display using the transmissive type modulator according to the present invention.

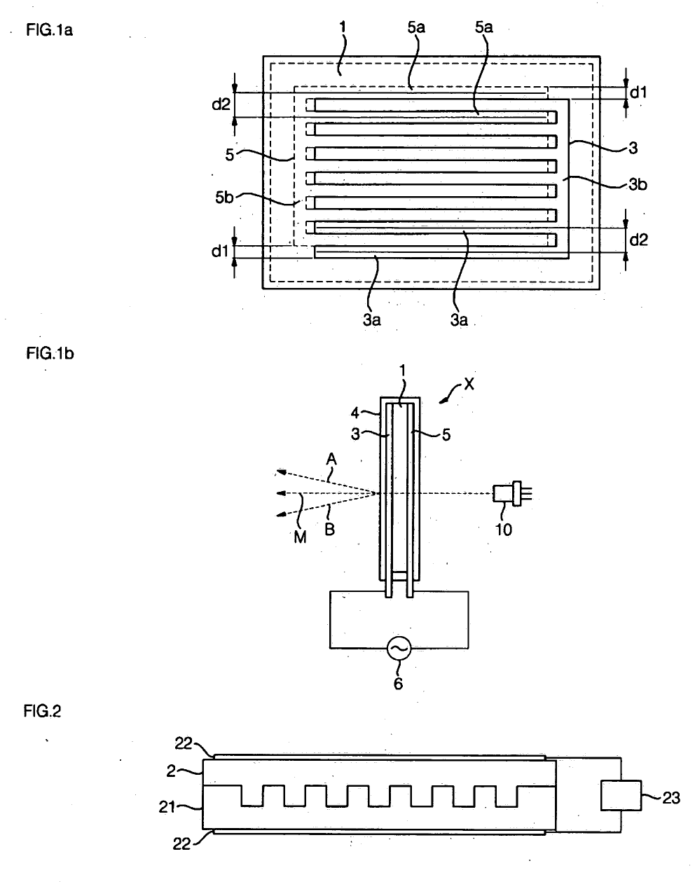

### DETAILED DESCRIPTION OF THE PREFERRED EMBODIMENT

Diffraction occurs when light passes through a medium in which a refractive index or an absorption is periodically modulated. For example, it is assumed that the refractive index of a phase diffraction grating member 21 is 1.5, and the refractive index of a phase modulation member 2 can be controlled within the range between 1.50 and 1.51 by applying an electric field. If the refractive index of the phase modulation member 2 is at 1.5 by applying the electric field thereto so that the refractive index of the phase diffraction grating member 21 and the phase modulation member 2 are the same, diffraction does not occur when light passes therethrough. Meanwhile, if the refractive index of the phase modulation member 2 is controlled at 1.51, diffraction occurs due to the different refractive indices of the phase modulation member 2 and phase diffraction grating member 21.

Also, the refractive index of a medium may be influenced by the wavelength or polarization direction of light when light passes through the medium. Particularly when the medium has optically anisotropic behavior, for example liquid crystal, a liquid crystal display therefore uses light that is linearly polarized by passing the polarizer, since the liquid crystal is considerably influenced by the wavelength or polarization direction of light. In the present invention, the polarization direction of an incident laser beam is determined so to maximize the variation of the refractive index when the laser beam passes through the medium.

The dynamically controllable light modulator according to the present invention, as shown in FIG. 2, includes the phase diffraction grating member 21, in which a periodic square wave shaped diffraction grating portion is formed, and the phase modulation member 2, which is attached to the diffraction grating portion of the phase diffraction grating member 21. Two transparent electrodes 22 are attached to opposite surfaces of the phase diffraction grating member 21 and phase modulation member 2, which are attached to each other. A certain electric field is applied to the transparent electrodes 22. The transparent electrodes 22 are fabricated by uniformly coating a transparent glass plate with ITO (Indium Tin Oxide). Such a light modulator employing two transparent electrodes may be used in a transmissive optical apparatus such as a transmissive type display. In addition, if one of the transparent electrodes is to be replaced by a metal electrode, the dynamically controllable light modulator may be used in a reflective optical apparatus such as a reflective type display. Such transmissive and reflective optical apparatuses will be discussed in detail later.

While the phase diffraction grating member 21 of the dynamically controllable light modulator has been fabricated as either of a Raman-Nath or a Bragg diffraction grating according to need, the present invention uses Bragg diffraction grating.

Whether the Bragg diffraction or the Raman-Nath diffraction is used in the dynamically controllable light modulator of this present invention can be determined by the parameter Q expressed by formula (1). As described above, if the parameter Q is over one, Bragg diffraction occurs; otherwise, Raman-Nath diffraction occurs. If the wavelength of the light is 632.8 nm and the grating has a grating spacing Λ of 1 μm and the refractive index of 1.5, the Bragg diffraction occurs in the condition of the thickness of the grating of over 0.4 μm. As explained above, the medium requires a thickness of 1.6 μm for diffraction efficiency of 100% so that Bragg diffraction occurs.

A thickness L of a phase diffraction grating of a dynamically controllable light modulator is not the overall thickness of the phase diffraction grating member 21 but the amplitude, that is, the height between the convex portions and the concave portions of the grating portion, which is one side of the phase diffraction grating member 21 (see FIG. 3).

Since brightness is important in a display, the display needs to possess high diffraction efficiency. In the case of Bragg phase diffraction grating, the diffraction efficiency η is expressed as follows:

$$η = {sin}^{2} ( \frac{π L Δ n}{λsinϕ} ) \qquad ( 2 )$$

wherein L is the thickness of diffraction grating; Δn is the modulation width of the refractive index of the diffraction grating; λ is the wavelength of light; and φ is an incident angle of the light. In order to achieve maximum brightness, the condition of the diffraction efficiency of 100% can be derived from the above formula (2). When the helium-neon laser beam (λ=632.8 nm) is used as a light source, and the grating spacing Λ of the phase diffraction grating member 21 is 1 μm, an incident angle of the Bragg diffraction φ is about 15 degrees. In this case, if the modulation width Δn of the refractive index of the phase modulation member is 0.05, the diffraction efficiency of 100% is achieved at the thickness L of 1.6 μm.

The phase diffraction grating member 21 of which thickness periodically changes, and which causes the periodic modulation of the refractive index, may be expressed as such thickness functions as sine, triangle, or saw tooth wave other than the square wave mentioned above. The phase diffraction grating is shown in FIG. 3.

Diffraction when the dynamically controllable light modulator is used as transmissive and reflective types is explained hereinafter. A light source (not shown) is positioned below the phase diffraction grating member 21 in the transmissive type modulator and above the phase diffraction grating member 21 in the reflective type modulator. The incident laser beam from the light source should pass the whole of the dynamically controllable light modulator.

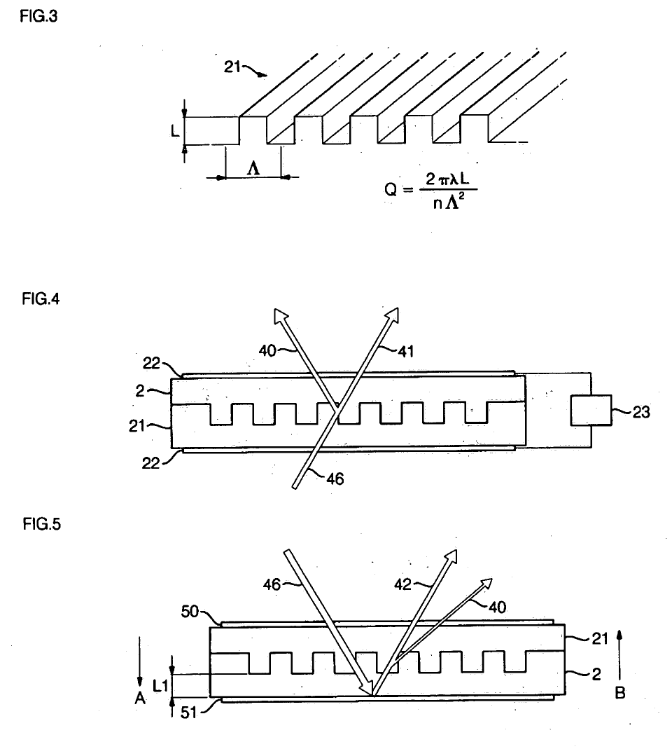

Referring to FIG. 4 concerning the Bragg diffraction of the transmissive type modulator, a laser beam 46, which is irradiated to the dynamically controllable light modulator, is separated into a transmitted light 41 and a diffracted light 40. Referring to formula (1) expressing the parameter Q, the lower limit of the grating spacing Λ of the phase diffraction grating member is half the value of the wavelength of the irradiated laser beam; and the upper limit thereof is determined by an angle between the transmitted light and the diffracted light. The angle θ between the transmitted light and the diffracted light is expressed by the grating spacing and the wavelength of the light source as follows:

$$sin ( \frac{θ}{2} ) = \frac{λ}{2 n Λ} \qquad ( 3 )$$

That is, in the dynamically controllable light modulator, the angle θ of 10 degrees makes a grating spacing of 2.4 μm; and the angle θ of 30 degrees makes the grating spacing as short as 0.8 μm.

In the present invention, by changing the refractive index of the phase modulation member according to supplied voltage, the phase of the light, which is transmitted through the phase modulation member 2, changes so that diffraction of light occurs in the phase diffraction grating member 21 and the phase modulation member 2. In the dynamically controllable light modulator of the present invention, inorganic nonlinear optical material, such as lithium niobate (LiNbO₃), which has excellent response characteristics, or organic material containing nonlinear chromophore, which is relatively inexpensive, maybe used as the phase modulation member 2. Preferably, liquid crystal may be used as the phase modulation member 2. The liquid crystal, which consists of bar-shaped or plate-shaped molecules, is classified to a Nematic type, a Smetic type, a Cholesteric type, and the like. The liquid crystal's physical properties, such as refractive index, permittivity, magnetic susceptibility, conductivity, and viscosity, are different for the cases when the propagation direction of light is parallel to the major axis of the molecule and perpendicular to the major axis of the molecule.

The operating principle of the dynamically controllable light modulator of the present invention is explained below. Since the periodic phase modulation is removed by controlling the refractive index of the phase modulation member 2 to the same index as that of a phase diffraction grating member 21 by applying an electric field, diffraction will not occur when the laser beam is irradiated to the dynamically controllable light modulator. If the refractive indices of the phase modulation member 2 and the phase diffraction grating member 21 deviate by changing the applied electric field as a result of the periodic phase change, diffraction will occur.

Referring to FIGS. 5 to 7, diffraction of the reflective type modulator is explained hereinafter in detail.

FIG. 5 shows that the laser beam 46, which is irradiated to the reflective type modulator through a transparent electrode plate 50, reflects from a metal electrode 51, and is then separated into a reflected light 42 and a diffracted light 40. That is, the laser beam 46 is separated into such transmitted and diffracted light when it passes through the diffraction grating, and the transmitted light that reflects from the metal electrode 51 is then diffracted when passing the diffraction grating.

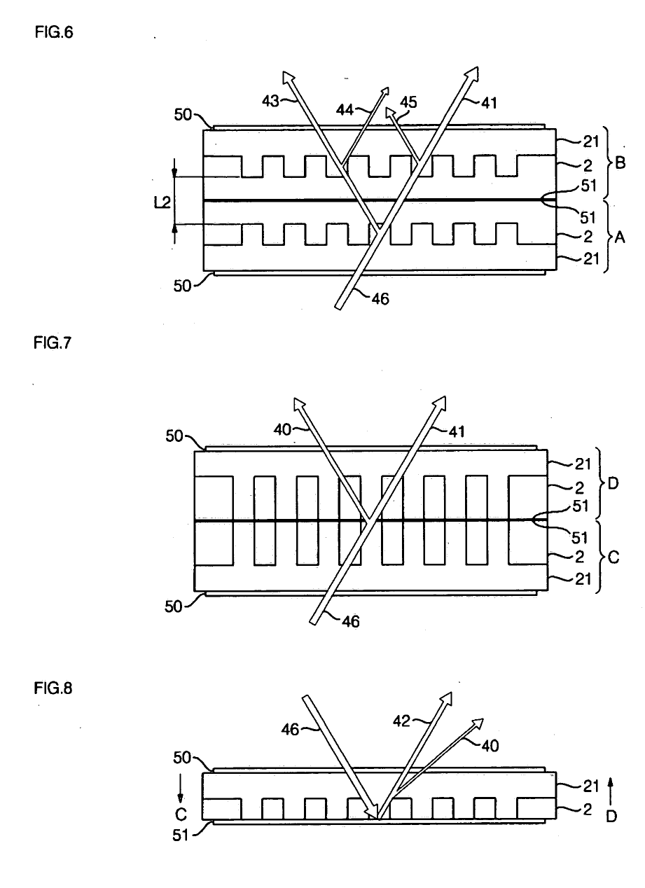

FIG. 6 shows a mirror image of the reflective type modulator to clearly illustrate the path of the laser beam 46 in FIG. 5. That is, FIG. 6 explains the laser beam path, which passes through the diffraction grating twice, in a developed plane. In FIGS. 5 and 6, the path where the laser beam first passes through the diffraction grating is designated by A; and the path where the transmitted light then passes through the diffraction grating is designated by B. Therefore, the reflective path L2 is double the height L1 of the phase modulation member 2.

In FIG. 6, the laser beam 46, which is irradiated to diffraction grating, is separated into transmitted light 41 and a first-order diffracted light 43 when the laser beam passes through a diffraction grating. Then, a second-order diffracted light 44 is generated when the first-order diffracted light 43 passes through the diffraction grating again after the first-order diffracted light 43 reflects from the metal electrode 51.l In this case, a third-order diffracted light 45 is generated when the transmitted light 41 passes through the diffraction grating after the transmitted light 41, which is first transmitted through the diffraction grating, reflects from the metal electrode 51. In this case, if the reflective path L2 is about zero by reducing the height L1 (shown in FIG. 5) of the phase modulation member 2 to about zero, the second-order diffracted light 44 and the third-order diffracted light 44 can almost be removed. Therefore, it is preferable that as shown in FIG. 8, the phase modulation member 2 is filled only in the concave portions of the phase diffraction grating member 21 in order to fabricate the phase modulation member 2 without the height L1. In FIG. 7, the path where the laser beam first passes through the diffraction grating is designated by C; and the path where the transmitted light second passes through the diffraction grating is designated by D.

Since diffraction efficiency of the reflective type modulator is twice that of the transmissive type modulator, the reflective type modulator can reduce driving voltage. In addition, the reflective type modulator can increase modulating amplitude in the intensity of the light although the same driving voltage is supplied to both types of modulators.

The dynamically controllable light modulator can be applied to a display by modifying the transparent electrode plate 50 in order to pattern the transparent electrodes in a two-dimensional array on the glass plate. By controlling the electric field applied to each of the transparent electrodes, the intensity of the laser beams that are diffracted in the grating can be controlled. Thus, each transparent electrode functions as a pixel in the display. Since the display using the dynamically controllable light modulator according to the present invention does not necessarily require elements such as a polarizer, which incurs optical loss, the display is very efficient.

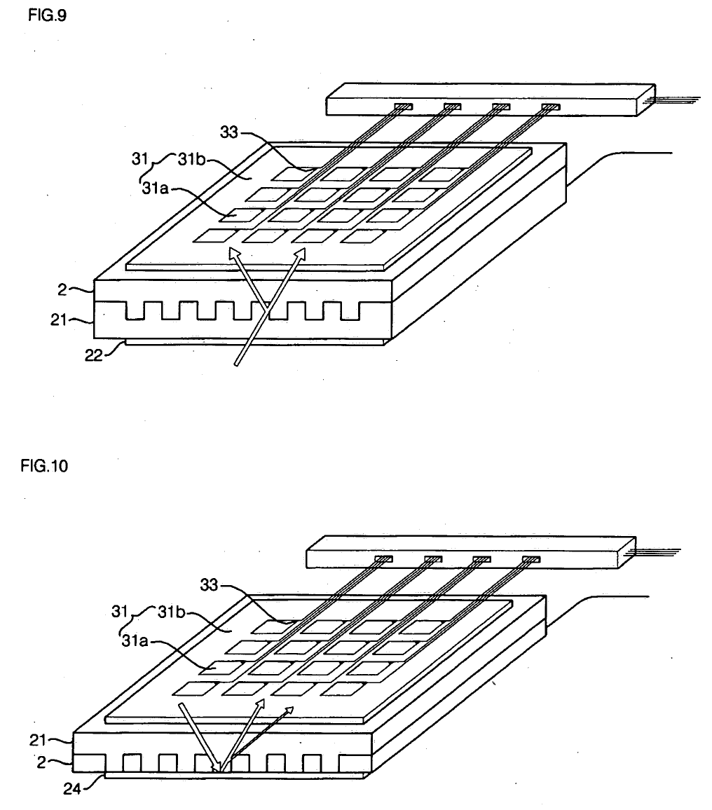

Referring to FIGS. 9 and 10, transmissive and reflective type displays are explained below. The laser beam is irradiated below the dynamically controllable light modulator in the transmissive type display and above the dynamically controllable light modulator in the reflective type display.

The transmissive display type shown in FIG. 9 uses a dynamically controllable light modulator shown in FIG. 2. A transparent electrode plate 31 consists of a glass plate 31b and transparent electrodes 31a, which are patterned in a two-dimensional array by coating the glass plate 31b with ITO (Indium Tin Oxide). Provided are drive elements 33, each of which is connected to each transparent electrode 31a. The drive elements are connected to a power supply driver. The transparent electrode 22, which is attached to the underside of the phase diffraction grating member 21, functions as a common electrode. Each of the transparent electrodes 31a patterned in a two-dimensional array functions as a pixel, of which the length should be above three times as long as the grating spacing Λ of the phase diffraction grating member 21.

FIG. 10 shows the reflective display wherein the transparent electrode plate 50 in the reflective type modulator is modified to the transparent electrode plate 31 as shown in FIG. 9, and the laser beam is irradiated to the transparent electrode plate 31.

The intensity of monochromatic laser beams of red (R), green (G) and blue (B) are controlled by various voltages supplied to the transparent electrodes patterned in the two-dimensional array so that a desired picture is displayed. The three monochromatic laser beams, which form a pixel, determine desired brightness and pixel color in accordance with the intensity of the modulated laser beam.

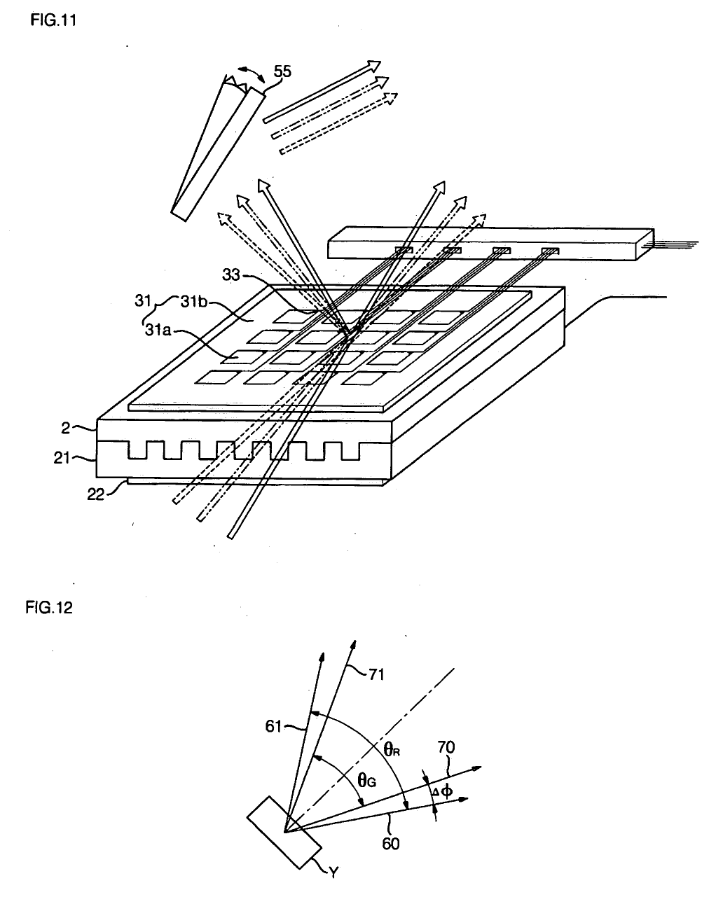

The three monochromatic laser beams are irradiated from the three separate light sources, respectively. The monochromatic laser beams of red, green and blue may be irradiated alternately and repeatedly, or simultaneously. The color of light is determined by the wavelength of light, and the incident angle and diffracted angle of light is also determined by the light's wavelength. Therefore, the control means for correcting the directions of the diffracted lights of the three laser beams, which are outputted by passing the transparent electrodes, are necessary. For example, as shown in FIG. 11, a rotatable mirror 55, of which the angle can be controlled, may be employed.

When the three monochromatic laser beams are irradiated to the dynamically controllable light modulator, if the directions of the three incident laser beams are controlled in consideration of diffraction efficiency, the three diffracted lights of the laser beams each having the same directions can be achieved without using the control means as shown in FIG. 11. A method for controlling the directions of the incident laser beams is explained in detail.

The angle that causes the Bragg diffraction is referred to as the Bragg angle. Although the Bragg diffraction can occur in an angle that is somewhat deviated from the Bragg angle, diffraction efficiency is reduced. Reduced diffraction efficiency is determined by the thickness of the diffraction grating or the parameter Q, which is expressed as follows:

$$\frac{η}{{η}_{0}} = {( \frac{sin ( L Δϕ / Λ )}{L Δϕ / Λ} )}^{2} \qquad ( 4 )$$

wherein Δφ is an angle that is deviated from the Bragg angle; L is the thickness of the diffraction grating; and Λ is the grating spacing.

In order to calculate the difference of the incident angles of lights having different wavelengths, formula (3) is used. The wavelengths of the three lights of R, G and B are 620 nm, 520 nm and 420 nm, respectively. For example, if a grating spacing Λ is 1 μm, angles θ between the transmitted light and the diffracted light satisfying the Bragg diffraction condition of the lights of R, G and B are θ_{R}=23.9 degrees, θ_{G}=20 degrees and θ_{B}=16.1 degrees. It is possible that the three diffracted lights progress in the same direction by selecting one light among the R, G and B lights as a reference and by controlling the incident angles of the two remaining lights in consideration of the angle θ. In this case, since the two remaining lights do not enter the diffraction grating with the Bragg angles, diffraction efficiency is reduced by an amount expressed as in formula (4). FIG. 12 shows that the lights of R and G, which enter the diffraction grating with the Bragg angles, are separated into transmitted lights and diffracted lights. In the case that the light of G is selected as a reference as in FIG. 12, the light of R must enter the grating with a predetermined angle that is deviated from the Bragg angle in order to direct said diffracted light 60 of R and diffracted light 70 of G to the same direction. The predetermined angle Δφ, which is half of the difference between the Bragg angles θ_{R}, θ_{G} for the lights of R and G, is given by (23.9−20)/2=1.95 degrees. In the same manner, an angle by which the incident angle of the blue light is deviated from the Bragg angle is half of the difference between the Bragg angles for the lights of B and G, that is, (20−16.1)/2=1.95 degrees. Referring to formula (4), when an angle Δφ deviated from the Bragg angle is 1.95 degrees and the diffraction grating has the thickness L of 1.6 μm and the grating spacing Λ of 1 μm, an amount of the reduction of the diffraction efficiency of the lights of R and B is very small, 0.1%. If the diffraction efficiency is sacrificed up to 1%, the thickness of diffraction grating can increase up to 5 μm without changing other conditions. If the directions of the diffracted lights of the three laser beams are the same by adjusting the incident angles of the three laser beams with a diffraction efficiency of below 1%, the display of the present invention will not require additional control means such as the rotatable mirror 55.

Such a display according to the present invention has good color reproducibility and can display an image of up to 600 inches with high quality such as sharpness, resolution and brightness due to the properties of the laser beam.

Although the present invention is described in detail with the embodiments, the invention is not limited thereto and can be changed or modified by those skilled in the art within the spirit and scope of the invention.

1. A dynamically controllable light modulator comprising:
a phase diffraction grating member wherein a diffraction grating portion of which the thickness changes periodically is formed on one surface of the phase diffraction grating member;
a phase modulation member whose one surface is attached to the diffraction grating portion of the phase diffraction grating member; and
electrodes provided on the other surfaces of the phase diffraction grating member and the phase modulation member.

2. The dynamically controllable light modulator according to claim 1, wherein at least one of said electrodes comprises a transparent electrode.

3. The dynamically controllable light modulator according to claim 1, wherein at least one of said electrodes comprises conductor with which a glass substrate is coated.

4. The dynamically controllable light modulator according to claim 1, wherein at least one of said electrodes comprises an ITO electrode.

5. The dynamically controllable light modulator according to claim 1, wherein at least one of said electrodes comprises metal.

6. The dynamically controllable light modulator according to claim 1, wherein said phase modulation member is provided only in concave portions of the diffraction grating portion.

7. The dynamically controllable light modulator according to claim 1, wherein said diffraction grating portion is expressed in the form of thickness functions such as a harmonic, triangle, square, or saw tooth wave.

8. The dynamically controllable light modulator according to claim 1, wherein refractive index of said phase modulation member changes as the voltage supplied thereto changes.

9. The dynamically controllable light modulator according to claim 1, wherein said phase modulation member comprises organic material containing nonlinear chromophore.

10. The dynamically controllable light modulator according to claim 1, wherein said phase modulation member comprises liquid crystal.

11. The dynamically controllable light modulator according to claim 1, wherein said phase modulation member comprises electro-optic crystals.

12. The dynamically controllable light modulator according to claim 1, wherein said phase diffraction grating member has predetermined thickness and grating spacing so that Bragg diffraction occurs.

13. The dynamically controllable light modulator according to claim 1, wherein a laser beam is irradiated to the dynamically controllable light modulator.

14. The dynamically controllable light modulator according to claim 1, wherein a polarization direction of said laser beam is determined so that the difference between the refractive index of said phase diffraction grating member and refractive index of said phase modulation member is maximized.

15. A display comprising:
a phase diffraction grating member wherein the diffraction grating portion of which thickness changes periodically is formed on one surface of the phase diffraction grating member;
a phase modulation member whose one surface is attached to the diffraction grating portion of the phase diffraction grating member;
plural transparent electrodes which are provided on the other surface of the phase modulation member, and which are patterned in a two-dimensional array;
common electrode which is provided on the other surface of the phase diffraction grating member;
one or more light sources; and
a power supply driver;
wherein each of the plural transparent electrodes is connected to a drive element, said drive elements and said common electrode are connected to the power supply driver.

16. The display according to claim 15, wherein said common electrode comprises metal.

17. The display according to claim 15, wherein said common electrode is transparent.

18. The display according to claim 15, wherein said one or more light sources comprises three separate sources for monochromatic laser beams of red, green and blue.

19. The display according to claim 18, wherein incident angles of the three laser beams are controlled so that diffracted lights fall in the same direction.

20. The display according to claim 18, wherein incident angles of the three laser beams are controlled so that diffraction efficiency of each laser beam is maximized, and the display further comprises a rotatable mirror for reflecting the diffracted lights so to be directed in the same direction.

21. The display according to claim 18, wherein said monochromatic laser beams of red, green and blue are irradiated alternately and repeatedly.

22. The display according to claim 18, wherein said monochromatic laser beams of red, green and blue are irradiated simultaneously.
